(19) United States
(12) Patent Application Publication
(10) Pub. No.: US 2009/0157422 A1
(43) Pub. Date: Jun. 18, 2009

(54) Internet-based balascopy-information exchange system

(76) Inventors: Boris Gorbis, Beverly Hills, CA (US); Vadim Kvitash, San Francisco, CA (US)

Correspondence Address: Vadim Kvitash, 2299 Post Street #306, San Francisco, CA, 94115, US

(21) Appl. No.: 12/002,231

(22) Filed: Dec. 17, 2007

(51) Int. Cl. G06Q 50/00

(52) U.S. Cl. 705/2; 705/1

(57) ABSTRACT

A medical internet-based Balascopic information exchange network for data exchange mainly between doctors working in various hospitals and in different geographical locations in a standard Balascopic format. In the system, the specific Balascopic-format data are combined into groups. This makes it possible to combine scarce Balascopic-format data relating to rare medical cases into a common group, to accumulate these rare data to the amount sufficient for statistic processing, and to make the obtained data available to the subscribers of the network in real time or with a predetermined frequency of access to the system. The accumulated medical information presented in the Balascopic units can be used for the organization of consultations between specialists about rare and difficult medical cases.

### FIELD OF THE INVENTION

The present invention relates to the field of medicine and, in particular, to an Internet-based diagnosing and treatment-aiding network and to a method based on the use of the aforementioned network. More specifically, the invention relates to a specific periodically updated internet-based information network that contains a plurality of coded data organized into groups and subgroups. The data contain results of analysis and, due to links between various subgroups, make it possible to collect more information on rare cases that report poor statistics.

### BACKGROUND OF THE INVENTION AND DESCRIPTION OF THE PRIOR ART

For optimal care and therapy, quantitative as well as qualitative judgments of the degrees of abnormalities should be made when diagnosing patients in the field of medicine. Previous studies have suggested that an analysis of combinations of a patient's laboratory data may be of greater aid in understanding the patient's condition than an analysis of individual items of data, per se.

Heretofore, one scientific method of diagnosing diseases from laboratory data has used statistical analysis of deviations from the normal range in a patient's data. The results obtained were arranged in the form of a circular coordinate system using radial axes that were calibrated according to the patient's laboratory parameters, with standard deviations of each parameter plotted on the respective axes. Following this, a pattern was created by interconnecting adjacent points on the axes. Diagnosis was performed by comparing the obtained pattern of an individual patient with reference patterns typical for certain diseases. (Refer to J. H. Siegel, “Relations Between Circulatory and Metabolic Changes in Sepsis,” 32 Ann. Rev. Med. [Annual Reviews, 1981] 175-194. Also see the “Patient Data System,” General Electric Medical Systems (advertisement), Critical Care Medicine, January/February 1976.)

While useful, these methods did not provide sufficient information for one to detect pathology with normal data and did not reveal qualitative and quantitative types of imbalances between parameters.

Another method has been suggested in an attempt to overcome these difficulties. This method was similar to the previous ones in that a circular-type presentation of parameters on radial axes was provided with values plotted on radial axes but expressed as a percentage of normal values rather than by standard deviations. (S. Nazari, et al., “A Multivariable Pattern for Nutritional Assessment,” Journal of Parenteral and Enteral Nutrition, 499, 1980.)

This method provided more distinguishable patterns than the previous one because the percentage scale was more sensitive than the standard deviation scale. Nevertheless, this method still did not provide sufficient information to obtain quantities and qualitative types of imbalances between parameters and did not reveal multiple imbalances that were present within the system.

In order to provide object quantitative and qualitative analysis of data obtained for different patients in laboratories and to determine imbalances between measured parameters and, thus, to confirm a diagnosis and to monitor the course of treatment, one of the applicants of the present patent application has developed the so-called Balascopic system for presentation and comparison of data measured in different measurement units and scales (See U.S. Pat. No. 4,527,240 issued to V. Kvitash in 1985). In other words, in a system in which multiple related parameters, such as blood chemistry data, are to be evaluated, such evaluation is facilitated by converting the data into special units as a percentage on a scale depicting the maximum and minimum empirical values for such parameters. Then, a normal relationship between pairs of such data is provided and compared with measured relationships between corresponding pairs of data, and quantitative and qualitative evaluations are made. Also, the complete set of data for such a system is plotted on respective radial axes in normalized units on a circular coordinate system, with the respective maximum and minimum for each parameter being marked on its radius. The maxima and minima are interconnected to form two closed lines, thereby providing an annulus representing the normal range. Measured parameters for various entities are similarly plotted and compared with the normal annulus or known abnormal annuli. Circular-point diagrams are provided, with points on a circular path representing respective parameters and respective pairs of points being connected when a normal quantitative relationship exists or when a specified type of qualitative abnormal relationship exists, thereby more readily depicting the condition of the system.

For example, if a patient's measured total serum protein is 7.3 mg/dl, this value is the minuend, the minimum empirical value (2.0 mg/dl) is the subtrahend, and the difference is determined, i.e., 5.3 mg/dl. This difference (5.3 mg/dl) is then multiplied by the normalized unit value, 11.1, to provide a special normalized value according to the invention, which is 58.9 units. The inventor has designated these special normalized units (regardless of the parameter represented) by the term Balascopic™ units [bala>balanced, and scopic>see], and hereinafter they will referred to as such for ease of discussion.

For example, the empirically existing maximum of the total serum protein in vivo comprises 11.0 milligrams (mg) of protein per tenth liter (deciliter—dl) of blood, and the minimum is 2.0 mg/dl. The range between these values is thus 11.0-2.0=9.0 mg/dl. This range is then converted into special normalized units on a scale of 100, such that each normalized unit corresponds to 100/9=11.1 actual units (in mg/dl). A patient's measured total serum protein value may be thus converted to normalized units by subtracting the minimum actual value from the patient's actual value and then multiplying the result by 11.1 or by 100/9.

FIG. 1 shows the Balascopic polar-coordinate diagram for a patient with normal blood chemistry. FIG. 1 also shows a circular coordinate system having twelve radial lines corresponding to twelve standard blood chemistry parameters: 1. albumin; 2. Ca.sup.++(Calcium ions); 3. phosphorus; 4. SGOT (serum glutamic oxytransaminase); 5. glucose; 6. alkaline phosphatase (alk. p'tase); 7. LDH (lactic dehydrogenose); 8. bilirubin total; 9. BUN (blood urea nitrogen); 10. uric acid; 11. cholesterol; and 12. total protein. The reference or normal range for these parameters is plotted in normalized, or Balascopic units (BU), on the respective axes in the above-described manner. The mean values of these parameters are then interconnected to form a closed, or endless, line 20.

The shaded ring-shaped or annular area 22 in FIG. 1 shows the normal range for a healthy population chosen by conventional statistical methods. Area 22 is drawn by plotting the normal lowest and highest values for each parameter on its radial axis and then interconnecting the lowest points and the highest points to form two closed lines (similar to line 22) and shading the area between these lines. Note that the parameters connected by line 20 all fall within the normal range.

In order to simplify visual comparison and to present it in a more obvious way, the radial axes in the circular diagram of FIG. 1 as well as in other diagrams, which are not shown, are arranged in the specific order indicated (rather than the standard sequence of a laboratory test routine) so that the boundaries limiting the normal range will define the substantially annular pattern shown. If the axes were arranged in an order corresponding to the sequence of a standard laboratory test routine, the pattern of the normal range would have been too complicated for comparison and too difficult to use as an effective aid in diagnosis.

FIG. 2 is an example of a similar circular diagram depicting abnormal patterns of blood chemistry typical for the various diseases indicated. In this figure, the corresponding normal (shaded) range pattern 22 is superimposed on the patient's annular blood chemistry plotted line. In FIG. 2, the blood chemistry for a patient with diabetes mellitus with Kimmelstiel-Wilson disease and secondary hyperparathyroidism is plotted as line 30.

It can be seen that in the Balascopic diagram shown in FIG. 2, the content of blood phosphorus, sugar, as well as data relating to BUN, uric acid, and cholesterol, exceed the range of the normal loop. The diagrams of the type shown in FIGS. 1 and 2 comprise visual and graphical information that can be presented in tabular format and can be statistically processed for grouping in order to correlate visual images and patterns of abnormalities with types of diseases. Furthermore, imbalances revealed by the Balascopic diagrams can be quantitatively estimated by the degree of imbalance in percent.

The Balascopic system of U.S. Pat. No. 4,527,240 was further improved, as disclosed in U.S. Pat. No. 6,768,948 issued in 2004 to V. Kvitash. More specifically, the “analysis-of-pair” method, which considered only relationships between pairs of parameters, was simplified by replacing the graphical linear representation of FIG. 1 by so-called Balascopic vectors, which show the direction of changes of the relationship from the normal and the length corresponding to the amount of change. Normal relationships are expressed by scalar values in the form of vertical linear sections, while deviations from the normal are expressed by vertical vectors having lengths corresponding to the magnitude of the deviation. The circular diagram method is improved by dimensionlessly resealing the Balascopic unit in FIGS. 2 and 3 into a system in which deviations for all parameters are shown from mean statistic values recalculated on the same radius of the circular diagram. The diagrams show three substantially concentric circles, of which the inner circle corresponds to the minimal normal values, the outer circle corresponds to the maximal normal values, and the intermediate circle corresponds to the mean statistical values. The latter are assumed as 100% normal value of corresponding parameters. With the use of such converted system, it becomes possible to present all deviations of diagnostic parameters from the normal condition in more visually obvious form and in relative Balascopic units, hereinafter referred to as “relative Balascopic units.” According to another embodiment for Balascopic representation of diagnostic data, the circular diagrams of the invention are developed into a linear form, which is more convenient for observing the dynamics of the disease by arranging the graphs plotted at time intervals, one beneath the other.

The matrix representation method is improved by rearranging the parameters into a conventional orthogonal matrix, wherein the diagonal cells contain Balascopic units combined with values of the parameters measured in natural units of these parameters, and wherein other cells contain values and symbols that characterize magnitude of change in relationships in comparison with normal relationships. The invention also improves the multiple relationship graphs by showing not only links between all normal and abnormal parameters with specific relationships, but also the sign of the change relative to normal change in terms of vectors, while the length of the vector shows the absolute value of the change.

FIG. 3 is an example of a circular diagram, which dimensionlessly rescales the Balascopic units of FIG. 1 into a system in which deviations for all parameters are shown from mean statistical values recalculated on the same radius of the circular diagram.

Nevertheless, the Balascopic systems described in the aforementioned patents are mostly localized within a single computerized network, e.g., of a certain hospital, and in case of rare diseases, such a localized Balascopic system may have insufficient information for determining correct conclusions or making decisions with regard to the diagnosis or selection of treatment methods.

### OBJECTS AND SUMMARY OF THE INVENTION

It is an object of the invention to provide an Internet-based diagnosing and treatment-aiding network based on the use of the aforementioned network. It is another object to provide the aforementioned network for doctors and other authorized individuals who subscribe to the sub-networks of other hospitals that may be located in the same areas, in other parts of the country, or even abroad. It is an object of the invention to make it possible to exchange data in a standardized form and to simplify and accelerate the retrieval of data due to the use of the balascopy. It is a further object to form a data base bank which operates in a real time and is constantly updated. It is a further object to provide doctors and other authorized medical personel and/or patients with an increased amount of data relating to rare diseases about which statistical data are scarce and insufficient for diagnosing and conclusions. It is another object to provide the aforementioned Balascopic system, which is periodically updated and operates in real time. It is a further object to provide a multilevel medical information system with presentation of data in Balascopic units and realized by means of the Internet, the system being one that can be used for the organization of consultations between specialists about rare and difficult medical cases.

The authors of the present patent application have developed a Balascopic information-exchange system based on observable phenomena of complex patterns of Internet-user connectivity and thus content distribution patterns. In the context of the typology introduced by the applicants, the term “content” means a common topic of the alliance. For example, such content may be the name of a disease. Often referred to as “networks,” these relational patterns fall into several distinctly different but as of yet undifferentiated topologies of human interaction. The properties of these groups (such as their geometry or structure as related to content, its values and value flow) and their systemic classification is the core topic of the newly developed system. The inventors herein offer an organic classification of the various types of alliances between doctors, patients, laboratories, etc., within a single local network as well as between networks in different geographical areas through use of the Internet.

In building the new Balascopic system, the applicants introduced special terminology that describes typology of organization and interaction between various groups of system users. These terms, the meaning of which is described later in the section “Detailed Description of the Invention,” are the following: roots, bushes, values, alliances, filters, etc.

A typical Internet-based Balascopic information exchange system of the invention consists of one or several sub-networks interconnected through the Internet. A single sub-network contains several roots (Doctor 1, Doctor 2, . . . Doctor N, Medical Laboratory, Hospital Library, etc.), and recipients, e.g., patients such as Patient 1, Patient 2 . . . Patient K. All of these roots and recipients are united by a common source or interest, which may be, e.g., specific diseases, and form an alliance. A Bush alliance can be formed by the primary root that sprouts a number of branches with some degree of consistency. For example, patients suffering from diabetes can be united into a diabetes-patient's bush alliance. Each bush alliance is connected through communication links, e.g., personal computers, to a server that is connected to the Internet. The Internet can be used for communication with other sub-networks and roots of these other sub-networks. All subscribers to the Balascopic network should use standardized forms of data, tables, and diagrams for compatibility of exchanged data, or the subscribers may use special conversion systems for coding and decoding data into and from the standardized form to specific local formats. Several levels of access to Balascopic information exist. For example, there may be a common switch that allows obtaining information for any and all subscribers of the system to non-confidential information, and there may be private switches that allow access to specific confidential information only by specified people, e.g., a certain group of doctors specializing in a predetermined field of medicine. Doctor 1 (Root 1) may receive information about the results of analysis from the Laboratory (Root 2) about Patient 1 (Recipient 1). Doctor 1 presents this specific information in the form of standardized Balascopic tables and/or graphical diagrams and sends this information to the server from where a doctor of another sub-network can obtain this specific information through the Internet by using his/her private code. One of the advantages of the system of the invention is that the system not only collects information about diseases but also actively analyzes the collected information and distributes it over various Balascopic subgroups. The subgroups of local Balascopic networks are united with similar subgroups of other local networks into a universal network that is transferred to a secondary level where the data are updated with a certain periodicity; when a predetermined amount of information is achieved, the summary of this information is sent to the related roots by means of feedback. This is especially important for collecting information about rare diseases for which statistics are absent in the local networks.

### BRIEF DESCRIPTION OF THE DRAWINGS

FIG. 1 is an example of a Balascopic polar-coordinate diagram for a patient with normal blood chemistry.

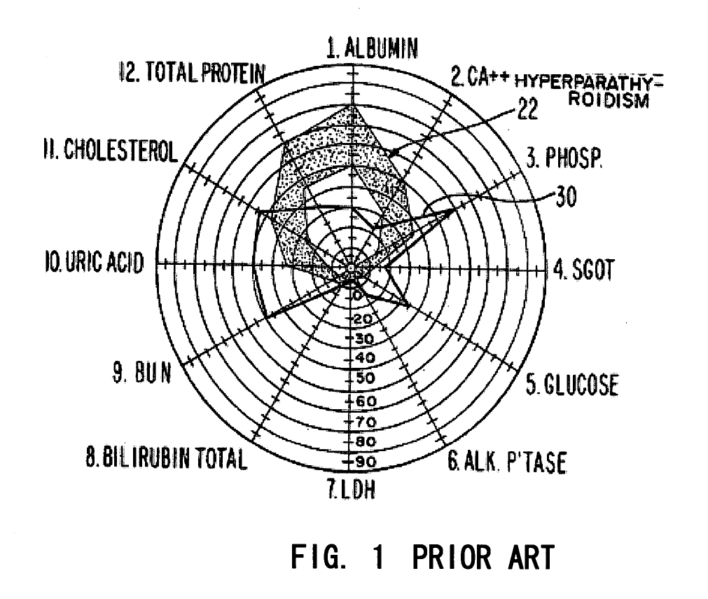

FIG. 2 is an example of a diagram similar to FIG. 1 but for a patient with abnormal blood chemistry and deviations from the normal pattern.

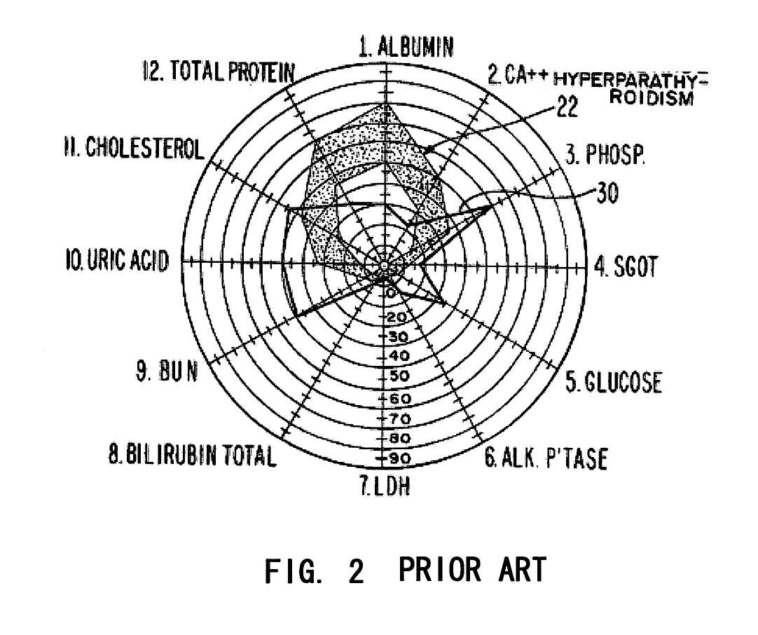

FIG. 3 is an example of a circular diagram, which dimensionlessly rescales Balascopic units of FIG. 1 into a system in which deviations for all parameters are shown from mean statistical values recalculated on the same radius of the circular diagram.

FIG. 4 is a block-diagram of a typical local Balascopic information-exchange network of the present invention.

FIG. 5 is a diagram, in which the circular diagrams of FIG. 3 is developed into a linear form for observing dynamics of variations in the relationships between the parameters by arranging the sequential graphs one underneath the other.

FIG. 6 is a block-diagram of an expanded Internet-based Balascopic information-exchange system that links together a plurality of local Balascopic networks.

### DETAILED DESCRIPTION OF THE INVENTION

The authors of the present patent application have developed a Balascopic information-exchange system based on observable phenomena of complex patterns of Internet-user connectivity and, thus, content distribution patterns.

Often referred to as “networks,” these relational patterns fall into several distinctly different but as of yet undifferentiated typologies of human interaction. The properties of these groups (such as their geometry or structure as related to content, its values and value flow) and their systemic classification is the core topic of the newly developed system. The inventors herein offer an organic classification of the various types of alliances between doctors, patients, laboratories, etc. within a single local network as well as between networks in different geographical areas through use of the Internet.

In building the new Balascopic system, the applicants have developed and introduced special terminology that describes typology of organization and interaction between different groups of system users.

More specifically, Internet-based communications redesign the patterns in which people interact. Internet allows formation of user groupings not bound by time or space limitations inherent in land-based interactions These complex systems are frequently identified as scale-free networks.

Another direction of network modeling comes from the emerging discipline of Relonics, a promising science of control, regulation, and coordination in super-complex systems and in systems with infinite complexity. Relonic reality is what penetrates, interconnects, and ties together all macro-, micro-, and nano-realities into individual organisms and networks and allows complex systems to overcome physical and other constraints imposed by natural laws holding true at lower levels. Living systems and human networks are not just complex, nonlinear, and unique but are fundamentally non-Euclidean in their architecture, organization, and functions, although they are often seriously oversimplified and presented in a quasi-Euclidian linear manner.

The obvious limitation of the “scale-free networks” (SFN) application to Internet communications is the forced elimination of the human user from the mathematics of flexible networking while the social research study of Internet communications is naturally framed by the qualitative research attention to observation of virtual community participants.

Appearance of new and more complicated systems of interaction between various objects, such as the above-mentioned Balascopic system of diagnosing and analyzing medical data with a plurality of interrelated parameters that can be changed in a wide range, led the applicants to the development of an Alliance Typology, which is a more integrated and organic classification that, in turn, led to the creation of a Balascopic-based information exchange network operating through such a powerful tool as the Internet.

According to Alliance Typology, there are five major alliances: (1) Bush, (2) Grove, (3) Park, (4) Forest, and (5) Swarm. Within each alliance format are two salient features: root(s) and value(s), which are identified by the applicant. A “root” in an alliance is a participant who either consistently originates or distributes content. Any content may have multiple roots, but an alliance has one source for each content item. This notion corresponds to “hubs” and “nodes” in the free-scale network paradigm. Any alliance can develop (spawn) multiple roots.

An originator (source) of content does not necessarily become an alliance root. His or her message/content item may be ignored once received. For a participant to be a root of an alliance, his/her content must have value for others, or he/she must redistribute valuable content to others with some degree of consistency. In this context, Value is convertible into a Balascopic-format data and means the level of importance and trust which other alliance participants attach to content originated from a given source. A typical measure of value is the quantifiable redistribution of a given content item received from a given source.

The second important feature of Internet-enabled networks (alliances) is the potential and actual flow of value. The value of content can be measured by the number of roots it spawns and the number of redistribution addresses that receive it. The higher the value, the greater the social capital that is attached to both the messenger and the message. Thus, a root is an alliance participant who by virtue of redistribution attaches value to a content item. Roots are not only distributors of information but are creators and distributors of value.

Roots do not act as indiscriminate feeders of value to an alliance; they serve as its filters, i.e., they filter out content without “value,” and other participants (such as top government officials) have to trust their sources and filtering process and receive the content with the knowledge of and confidence in its root source.

Effective Value is the ratio between the number of addresses to which an item is distributed and the number of (redistribution) roots spawned.

Each Bush alliance may have a primary root and a backflow loop of the same (error) or new content item from participants to the root. One content item may spraw another root that redistribute it to his/her own alliance. This is basically how jokes, pictures, myths, and funnies flow through the Internet There may be more complex Bush formations, i.e., with the content items sent from participant to root, two secondary root spawnings, and several loops in case of interparticipant interaction.

According to the applicants, the following rules should be observed for the Bush alliance:
a. A Bush alliance is formed from a single common source, i.e., the primary root that sprouts a number of branches with some degree of consistency.
b. The number and identity of branches is neither limited nor fixed.
c. Any branch recipient may backflow to the root, often with hope for validation and redistribution to branches with some degree of consistency.
d. Any Bush branch (address) can become a secondary root, thus sprouting its own Bush alliance often unrelated to the primary root.
e. Any Bush alliance participant can engage anyone into coupling without invitation into alliance.
f. Any Bush alliance participant can opt out of the alliance by either rejecting items from the source or refusing to further redistribute them.
g. Any primary root may cut off a branch by refusing to further distribute to that branch, e.g., for failure to backflow to the root or for any other reason.

A Grove alliance usually has multiple roots but shares a common “source.” Its members come from or jointly develop a common experience. An example of a Grove alliance is a group of women having breast cancer, a group of people having stomach cancer, a group of people having diabetes, mothers of children with a rare disease, etc. Another example of a Grove alliance is a group of doctors specializing in treating tumors, etc.

The following should hold true for Grove alliances:
a All participants are potential roots.
b. All participants know each other addresses.
c. All roots are potentially equal distributors of value.
d. Actual value flow in these alliances tends to be higher than in other networks.

The alliance system can be further exemplified by other typologies such as further development of the Grove alliance, as well as the Park alliance, Forest alliance, and Swarm alliance, which are considered in more detail in the article by B. Gorbis and V. Kvitash entitled “Web-Enabled Alliances: Flexible Human Network” published in Proceedings of the 2007 International Conference on Semantic Web and Web Services, Worldcomp '07, Jun. 25-28, 2007, Las Vegas, Nev., USA, CSREA Press.

The following description relates to an Internet-based Balascopic information-exchange system of the present invention by using the conception and terminology of the alliance typology developed by the applicants.

A typical Internet-based Balascopic information exchange system of the invention consists of one or several sub-networks interconnected through the Internet. A single sub-network contains several roots (Doctor 1, Doctor 2, . . . Doctor N, Laboratory, Patient 1, Patient 2, . . . Patient K). Several roots having common interests or functional similarity may be combined into Bush alliances. In other words, a plurality of participants united by a common topic may form an alliance. For example, patients suffering from diabetes can be united into a diabetes-patient's Bush alliance. Each Bush alliance is connected through a communication link, e.g., personal computers, to a server that is connected to the Internet. The Internet can be used for communication with other sub-networks and roots of these other sub-networks. All subscribers to the Balascopic network should use standardized forms of data, tables, and diagrams for compatibility of exchanged data, or they may use special conversion systems for coding and decoding data into and from the standardized form to specific local formats. The alliance participants can exchange information in a selected manner, including exchange of information in the form of Balascopic-format data. The selected manner means, e.g., that only doctors may have access to a predetermined information to which patients do not have access.

Several levels of access to Balascopic information exists. For example, there may be a common switch that allows obtaining information for any and all subscribers of the system to nonsecret information, and there may be private switches that allow access to specific secret information only by specified people, e.g., a certain group of doctors specializing in a predetermined field of medicine. Doctor 1 (Root 1) may receive information about the results of analysis from the Laboratory (Root 2) about Patient 1 (Root 3). Doctor 1 presents this specific information in the form of standardized Balascopic tables and/or graphical diagrams and sends this information to the server from where a doctor of another sub-network can obtain this specific information through the Internet by using his/her private code.

Having described the Balascopic information-exchange system of the invention in general, let us now consider some examples of the Balascopic networks of the invention suitable for medical applications.

### Local Balascopic Network

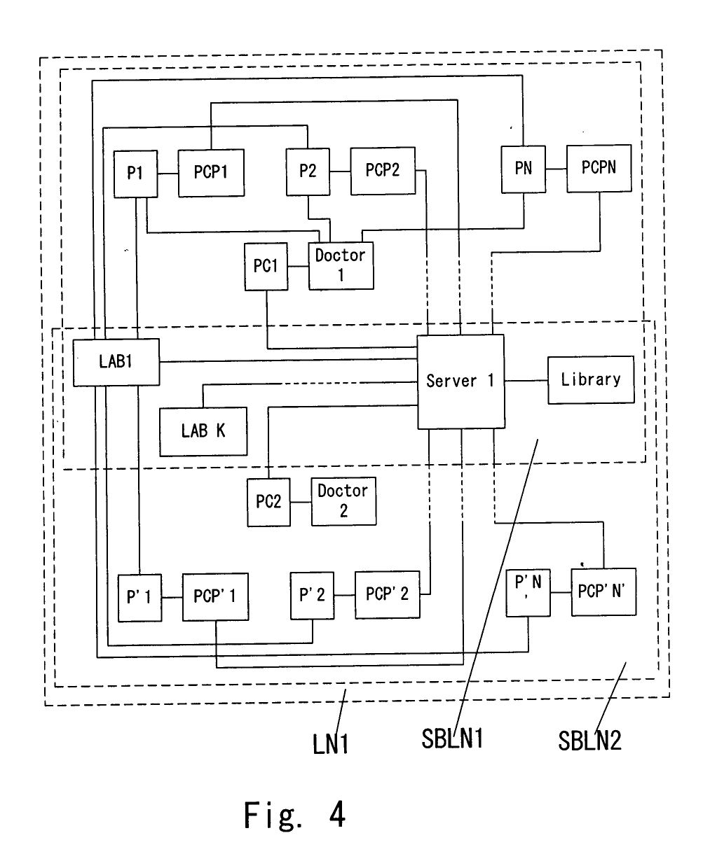

A typical local Balascopic information-exchange network of the invention is shown in FIG. 4. Such a system can be realized on the basis of a single hospital or a hospital with local affiliations without the use of links through the Internet. Nevertheless, the local Balascopic network is suitable for connection as a subsystem to other similar local networks through the Internet. Within the limits of a single hospital may be several local networks relating to different Contents (see the above definition of Content). For example, separate local Balascopic networks may exist for such Contents as diabetes, cancer, allergy, etc. Thus, the doctors who specialize in treating diabetes and the patients who suffer from diabetes will constitute, respectively, the roots and recipients of an appropriate local network and will form an alliance.

If the local network belonging to different Contents is built on the above-described principle of types of alliances, such as Bush alliance, Grove alliance, etc., they will have identical structures. Therefore, it should be understood that the following description of the block diagram shown in FIG. 4 relates to a local network of any Content. Just for the purpose of example only, the local network shown in FIG. 4 will be considered with reference to Content such as diabetes.

As can be seen in FIG. 4, the local network LN1 consists of several local sub-networks SBLN1, SBLN2, . . . , the outlines of which are shown in FIG. 4 by broken-line contours. Each local sub-network includes a personal computer of one doctor and personal computers of all patients of this doctor. Thus, as shown in FIG. 4, a personal computer PC1 of Doctor 1 is linked to a personal computer PCP1 of Patient 1, a personal computer PCP2 of Patient 2, . . . a personal computer PCPN of Patient N. A personal computer PC2 of Doctor 2 is linked to a personal computer PCP′1 of Patient 1′, a personal computer PCP′2 of Patient 2′, . . . a personal computer PCPN of Patient N′, and so on. The heart of the local nertwork LN1 is a Server 1 which is common for all sub-networks SBLN 1, SBLN2, . . . SBLNN and to which all personal computers of the doctors and patients have an access. The local network LN1 also contains a laboratory or several laboratories such as LAB1, LAB K, a Library, and may contain other units (not shown) that are all connected to Server 1. It is understood that Server 1 may have access to the Internet. The connection between some participants of the local network LN1 who are not connected to each other through hardware is carried out through the Internet. For example, a doctor can connect to the laboratory via Server 1 but cannot have a direct connection to a patient who is located in another geographical location, e.g., at home, and connection to such a patient is carried out through the Internet.

It is possible that the local sub-networks may share common participants such as servers, laboratories, and libraries. For example, Doctor 1 of local sub-network SBLN1 and Doctor 2 of local sub-network SBLN2 may have access to the common Server 1, LAB1, and Library.

In terms of the above-described typology, the doctors who specialize in treating a predetermined disease and patients suffering from this disease may form an alliance. For example, Doctor 1 who specializes in treating diabetes, his/her patients suffering from diabetes, LAB1 and a Data library (not shown) may form an alliance. Depending on the degree of development, the alliance may form a Bush alliance, Grove alliance, etc. Since the doctors, laboratories, and the data library produce value, they may be classified as roots, while the patients may be categorized as recipients. In compliance with the network-structure rules described above, the participants of the alliance also may be organized into a local sub-network.

Server 1 of the local network LN1 is equipped with a memory unit capable of storing a large amount of information for a hospital of an average size (several dozen GBs). The library occupies a part of the server memory. An advantage of the use of the Balascopic system is that it allows minimization of a large number of parameters by making emphasis on a small number of most essential parameters convenient for comparison. For example, if the entire medical case of a patient has been introduced into the server in the electronic form, this would have occupy several megabytes of the memory space. Taking into account a large number of doctors and patients, as well as the data stored in the data library, such a system of recording of information would be cumbersome and inconvenient for analysis of the accumulated data. Contrary to this, the extracted data presented in the Balascopic format, e.g., results of analysis of sugar content in blood, will occupy only several kilobytes, especially in the graphic form, and this will accelerate and simplify access to the data, as well as the analysis and comparison of the data.

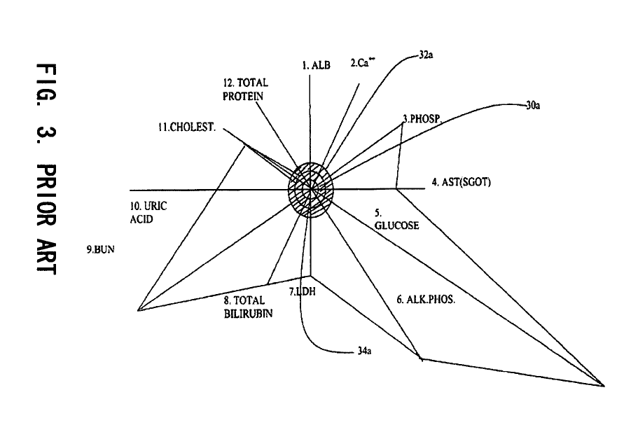

The local Network LN1 operates as follows. When Doctor 1 finds it necessary to test Patient 1 for the presence of diabetes, he/she sends Patient 1 to a laboratory, e.g., Laboratory 1. Upon receiving the results of analysis, preferably in the form of an electronic file, Doctor 1 converts the obtained data into a Balascopic form of the type shown in U.S. Pat. No. 6,768,948. The Balascopic information, presented in the form of matrix tables or graphs of the type shown in FIG. 3, is analyzed by Doctor 1 in accordance with principles described in U.S. Pat. No. 4,527,240 and/or U.S. Pat. No. 6,768,948. Based on the results of the analysis, Patient 1 can be classified as Normal (when all analysis data are within normal ranges), Group Risk 1, Group Risk 2 (groups of different degrees of risk but within or close to the norm), Abnormal (with data beyond the allowable limits), and Extremely Abnormal (extremely high risk). Doctor 1 then sends the data converted into the Balascopic form to the memory of Server 1 for recording in the files belonging to Doctor 1 (Root 1). It can be considered that these data be Balascopic-format data, e.g., data convertible into Balascopic units. A similar procedure is carried out by other doctors, e.g., by Doctor 2 with respect to Patient 2, . . . Doctor N (not shown) with respect to Patient PN. Thus, the Server 1 accumulates a plurality of Balascopically treated data that can be retrieved by any doctor or by any authorized alliance participant. For this purpose, alliance participants may have different degrees of access to the Server 1 data through a common switch (general information access to any alliance participant), private group switch (known only to a certain group of participants), or a personal private switch (known only to a specified individual).

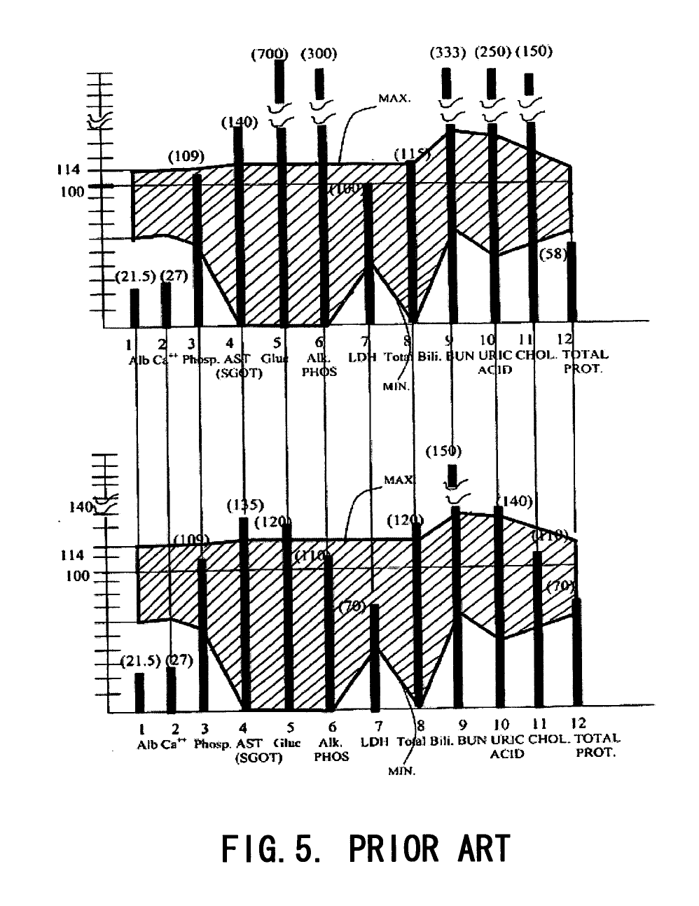

The collected data are further classified and divided into subgroups by degrees of risks and abnormalities. Accordingly, each doctor of an alliance can access to any case stored in the system in real time. The data are constantly updated, and information about the update is sent to the personal computers of doctors with a certain periodicity by means of feedback. It is understood that data obtained by the doctors are used not only for diagnosis but also for current treatment of the patients, and the treatment data may also be collected and stored in the system. As a result, it becomes possible to use the network shown in FIG. 4 in a variety of ways. For example, the dynamics of a patient's condition can be observed by using a graph of the type shown in FIG. 5, which is self-explanatory and shows changes in the patient's conditions over time. The designations and explanations to this diagram can be found in U.S. Pat. No. 6,768,948. More specifically, FIG. 5 shows a graph, in which the circular diagram of FIG. 3 is developed into a linear form for observing dynamics of variations in the relationships by arranging the sequential graphs one underneath the other. The abscissa axis is used for vertical axes of the parameters which are arranged in a predetermined sequence. The ordinate axes are used for plotting values of the parameters in terms of relative Balascopic units with respect to the norm. The norm is shown by the horizontal line with the ordinate of 100%. The upper curve MAX is the boundary of the maximal normal value, and the lower curve MIN is the boundary of the minimal normal value. Such a representation is more convenient for observing the dynamics of the disease by arranging the graphs plotted at time intervals, one beneath the other. From comparison of the upper and lower graphs of FIG. 5, one can see that the lower graph plotted after a certain time period shows improvement in the condition of some parameters as a result of treatment.

### Internet-Based Balascopic Network

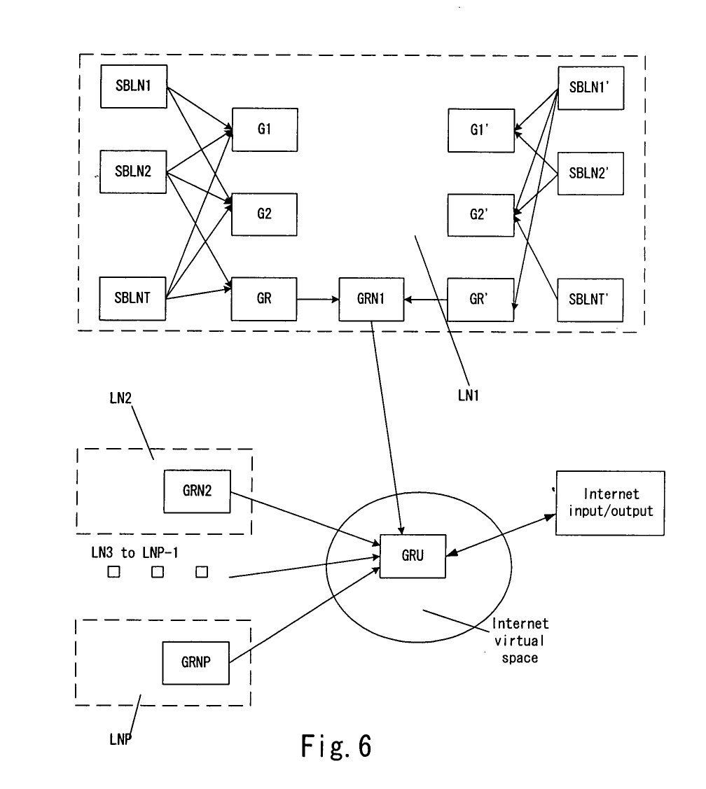

One of advantages of the local Balascopic information-exchange network, such as LN1, is that it can be connected to other local similar networks of individual hospitals through such a powerful communication and information-searching tool as the Internet. In this case, the aforementioned risk and abnormality groups are combined into highly developed groups of large data accessible to specified members of an alliance, while the alliance, itself, is expanded by including new participants. It is understood that in the case of an Internet-based Balascopic-format data-exchange diagnosing and analyzing system of the type shown in FIG. 6, the newly formed alliance should have a web page that will be placed on a selected server SVC (not shown). In this case, local networks LN1, LN2, . . . (FIG. 6) can be combined into a developed Internet-based Balascopic information exchange network that covers a sufficiently large area that goes beyond a local geographic area, e.g., beyond the boundaries of one country. Other local networks are not shown in detail since they may have contents and structures similar to local network LN1 shown in FIG. 4. It should be noted, however, that all local networks have their inputs and outputs in the form of Balascopic-format data, which are standardized for all component local networks.

In FIG. 6 the areas covered by the Internet is shown as the Internet Virtual Space. The expansion of the Balascopic information exchange networks results in the following significant advantages. 1) The statistic data base is expanded, and data dispersion is reduced which reflects on improved reliability of diagnostics. 2) Previously rare data will now be reclassified as non-rare data with amount of recipients (patients) sufficient for further division into subgroups and for revealing more detailed information on the course of disease, diagnosis, and treatment. 3) Medical personnel of underdeveloped and developing countries which do not possess the latest diagnostic equipment may obtain access to a large amount of data obtained in developed countries on the basis of sophisticated modern diagnostic equipment and treatment apparatuses and instruments. 4) The expanded massive of accumulated data makes it possible to obtain more trustworthy statistic that makes it possible to analyze local health-affecting factors such as climate, food, environment conditions, etc. 5) Moreover, global information exchange system in a Balascopic format is advantageous in that the balascopy symbols function in this case as a standard data-exchange means, which is impossible otherwise in view of differences in different national format used for description, e.g., of diseases, diagnoses, etc. 6) The Balascopic system of the invention makes it possible to form a data base bank which operates in a real time and is constantly updated.

In FIG. 6, symbols G1, G2, GR, G1′, G2′, GR′ designate groups of data collected from various local sub-networks SBN1, SBN2, . . . SBNt′ which constitute components of the local Balascopic information exchange network LN1. The arrows show links between these data groups and the local sub-networks. The data groups are different in the degree of data frequency. This means that if group G1 may have amount of data sufficient for some statistic analysis, group GR may have amount of data that can be considered as rare and insufficient for the analysis and conclusion. The local sub-networks can be combined into at least one local network, wherein the participants are divided into participant groups based on predetermined Balascopic-format data common for each group, and, depending on the number of participants, the participant groups are differentiated as groups having a number of participants suitable for statistic processing of the Balascopic-format data and groups having a number of participants insufficient for statistic processing of the Balascopic-format data.

An advantage of the Internet-based Balascopic information exchange system of the invention is that through the Internet such rare data can be accumulated into a Unified Rare Group GRU from other local networks LN2, . . . LNP. The GRU may grow to such a level that it ceased to be rare and becomes a group acceptable for statistic analysis. In fact, the GRU constitutes a data base bank which operates in a real time and is constantly updated. The alliance is variable in time due to variations in the number of the participants.

The unified rare participant groups can be updated with new participants of these groups and the updated information may be available to the selected members of the alliance through the Internet with a predetermined frequency or in real time.

The Internet-based Balascopic information-exchange system shown in FIG. 6 not only passively accumulates the medical data but may also actively interact with participants of the local networks via feedback links. For example, depending on the severity of the patient conditions expressed in the form of the accumulated Balascopic-format data, these data can be classified into groups (grove alliances) having different level of risk, and when a predetermined threshold is reached, e.g., in the most risky group, the data relating to this grove alliance are sent though the Internet to the alliance participants via the feedback. The value of the threshold (frequency of cases) can be adjusted and the data can be used for adjusting the patient monitoring conditions.

In principle, the system of FIG. 6 is the same as one shown in FIG. 4, except that the servers of the local networks, such as servers SV1, SV2, . . . are connected into a common web, the address of which is available on the Internet, and assigned to a single common server SVC (not shown).

Thus it has been shown that the present invention provides an internet-based diagnosing and treatment-aiding network based on the use of the aforementioned network. The invention provides the aforementioned network for doctors and other authorized individuals who subscribe to the sub-networks of other hospitals that may be located in the same areas, in other parts of the country, or even abroad. The system provides doctors and other authorized medical personal and/or patients with an increased amount of data relating to rare diseases about which statistical data are scarce and insufficient for diagnosing and conclusions. The aforementioned Balascopic system is periodically updated and operates in real time. The system provides a multilevel medical information system with presentation of data in Balascopic units and realized by means of the Internet, the system being one that can be used for the organization of consultations between specialists about rare and difficult medical cases. The use of the Balascopic system makes it possible to exchange data in a standardized form and to simplify and accelerate the retrieval of data.

The above described sub-networks and networks contain many specificities and should not be construed as limitations of the scope of the invention, but rather as examples of several preferred embodiments thereof. Various other embodiments and ramifications are possible within its scope. The above-described Balascopic information exchange system described above is not limited only to the doctor-patient-laboraty-library scheme which has been given only as an example. The system of the invention has many other applications of high potentials. For example, the Internet-based Balascopic information exchange system of the invention can be used for obtaining information on clinical tests of various drugs. It is known that clinical tests of new medicines for FDA approval are very expensive and long procedures. Thus, obtaining of additional information on the effect of the drug from another geographical area or country may be of a great value. Furthermore, instead of blood chemistry, different medical data such hematological data, neurological data, dietary data, coronary data, etc., can be converted to Balascopic units and charted. In addition to medicine, the invention can be used in other fields where multiple related parameters are found, such as analysis of cosmetics, corporate security evaluation, competitive sports analysis and prediction, etc. Accordingly the full scope of the invention should be determined not be the examples given, but by the appended claims and their legal equivalents.

1. An Internet-based balascopy data information exchange system comprising: an alliance of a plurality of participants who are united by a common topic and each of which has an access to a personal computer and produces certain value convertible into a Balascopic-format data; and at least one local sub-network through which the participants exchange the aforementioned Balascopic-format data in a selected manner including exchange of information in the form of Balascopic-format data; said alliance being variable in time due to variations in the number of the participants;
the Balascopic-format data being standardized for all the participants of the alliance.

2. The Internet-based balascopy data information exchange system of claim 1, wherein according to typology classification the alliance comprises a grove.

3. The Internet-based balascopy data information exchange system of claim 1, wherein at least one local sub-network comprises: a plurality of said personal computers; a server with a memory unit selectively connected to the personal computers and selectively connected to the Internet; and at least one laboratory.

4. The Internet-based balascopy data information exchange system of claim 2, wherein at least one local sub-network comprises: a plurality of said personal computers; a server with a memory unit selectively connected to the personal computers and selectively connected to the Internet; and at least one laboratory.

5. The Internet-based balascopy data information exchange system of claim 1, comprising a plurality of said local sub-networks that are combined into at least one local network, wherein the participants are divided into participant groups based on predetermined Balascopic-format data common for each group; depending on the number of participants, said participant groups being differentiated as groups having a number of participants suitable for statistic processing of the Balascopic-format data and groups having a number of participants insufficient for statistic processing of the Balascopic-format data.

6. The Internet-based balascopy data information exchange system of claim 5, comprising a plurality of said local networks, the aforementioned groups having a number of participants insufficient for statistic processing of the Balascopic-format data being combined into at least one unified rare participant group, the accumulated number of participants in which is updated with a predetermined frequency and is available for selected members of the alliance through the Internet.

7. The Internet-based balascopy data information exchange system of claim 1, wherein the alliance of a plurality of participants comprises at least one doctor, patients, and said at least one laboratory.

8. The Internet-based balascopy data information exchange system of claim 1, wherein the alliance of a plurality of participants comprises at least one doctor, patients, and said at least one laboratory.

9. The Internet-based balascopy data information exchange system of claim 3, wherein the alliance of a plurality of participants comprises at least one doctor, patients, and said at least one laboratory.

10. The Internet-based balascopy data information exchange system of claim 5, wherein an alliance of a plurality of participants comprises at least one doctor, patients, and said at least one laboratory.

11. The Internet-based balascopy data information exchange system of claim 1, wherein the common topic is a disease.

12. The Internet-based balascopy data information exchange system of claim 3, wherein the common topic is a disease.

13. The Internet-based balascopy data information exchange system of claim 5, wherein the common topic is a disease.

14. The Internet-based balascopy data information exchange system of claim 6, wherein the common topic is a disease.

15. The Internet-based balascopy data information exchange system of claim 6, wherein the aforementioned groups having a number of participants insufficient for statistic processing of the Balascopic-format data is converted into aforementioned groups having a number of participants sufficient for statistic processing of the Balascopic-format data when the aforementioned accumulated number reaches a predetermined value.

16. The Internet-based balascopy data information exchange system of claim 15, wherein an alliance of a plurality of participants comprises at least one doctor, patients, and said at least one laboratory.

17. The Internet-based balascopy data information exchange system of claim 15, wherein the common topic is a disease.

18. The Internet-based balascopy data information exchange system of claim 16, wherein the common topic is a disease.
